(19) United States
(12) Patent Application Publication
(10) Pub. No.: US 2007/0106437 A1
(43) Pub. Date: May 10, 2007

(54) Apparatus and method of managing telematics application based on vehicle status

(76) Inventors: Min Jung Kim, Daejeon-city (KR); Yeon Jun Choi, Daejeon-city (KR); Young Bag Moon, Daejeon-city (KR); Sun Joong Kim, Daejeon-city (KR); Oh Cheon Kwon, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/586,210

(22) Filed: Oct. 25, 2006

(30) Foreign Application Priority Data
Nov. 7, 2005 (KR) 10-2005-0106035

(51) Int. Cl. G01M 17/00

(52) U.S. Cl. 701/29

(57) ABSTRACT

Provided is an apparatus and method of managing a telematics application based on a vehicle's status. The apparatus includes an application install manager which sets execution condition information including information related to a vehicle's status at which the application is activated, a vehicle's status detector which detects the vehicle status, and an application execution manager which recognizes the application that is activated when detecting a vehicle's status, and executes the application. Accordingly, executing a telematics terminal application supports safe driving. In addition, when in an emergency situation, a resource can be rapidly ensured, and an application for handling the emergency situation is performed, thereby effectively overcoming the emergency situation.

### CROSS-REFERENCE TO RELATED PATENT APPLICATION

This application claims the benefit of Korean Patent Application No. 10-2005-0106035, filed on Nov. 7, 2005, in the Korean Intellectual Property Office, the disclosure of which is incorporated herein in its entirety by reference.

### BACKGROUND OF THE INVENTION

1. Field of the Invention

The present invention relates to telematics, and more particularly, to an apparatus and method for managing a telematics application based on a vehicle's status.

2. Description of the Related Art

Telematics is an integration system which provides a variety of information and services to a driver through an information terminal within a vehicle by using a position determination technique and a system capable of interactive communication. A telematics terminal connects a variety of devices within the vehicle, communication devices, position determining devices, information devices, and the like, so as to provide a variety of services by communicating to a server, so as to function as an interface for the driver.

Researches related to the telematics are widely being conducted. For example, Korean Patent Application No. 10-2004-7011961 entitled “Middleware Service Layer For Platform System For Mobile Terminals” focuses on a middleware layer for loading, installing, and executing application software within the mobile terminal platform. In addition, Korean Patent Application No. 10-2003-0000058 entitled “System And Method For Managing Application” focuses on a system and method of managing an application, which dynamically extends a function of a controlled device in a home-network environment. In addition, Korean Patent Application No. 10-2002-0068991 entitled “Telematics System And Oil Station Guide Method Thereof” discloses a telematics system and an oil station guide method thereof, which finds a nearest oil station and guides towards it when oil needs to be refueled while driving to a destination.

Applications are installed in the vehicle to provide a variety of telematics services. In this case, a mechanism for controlling the applications has to be provided so that the safe driving of the vehicle is not interfered with. With the development of a variety of telematics applications (e.g., navigation, infotainment, personal assistant service, etc), each application installed in the terminal has to be managed so that the driver can drive safely without interruption from any of the applications. For example, while driving, an application that may distract a driver's attention has to be restricted. Furthermore, when an emergency situation occurs, an application for handling the emergency situation has to be rapidly and preferentially performed. Therefore, the terminal has to be able to manage execution of a variety of services based on a vehicle's status, so that an application that may distract the driver's attention while driving is prevented from executing by placing an application execution manger in the telematics terminal, or so that an application for handling an emergency situation can be preferentially performed in emergency situations such as mechanical troubles or accident. However, since conventional telematics do not provide a mechanism for controlling a telematics application based on a vehicle's status, there is a drawback in that the vehicle is ineffective in terms of safe driving or resource usage.

### SUMMARY OF THE INVENTION

The present invention provides an apparatus for managing a telematics application based on a vehicle's status, which supports safe driving and rapidly deals with an emergency situation.

The present invention also provides a method of managing a telematics application based on a vehicle's status, which supports safe driving and rapidly deals with an emergency situation.

According to an aspect of the present invention, there is provided an apparatus for managing a telematics application based on a vehicle status, comprising: an application install manager which sets execution condition information including information related to a vehicle's status at which the application is activated; a vehicle status detector which detects the vehicle's status; and an application execution manager which recognizes the application that is activated when in the detected vehicle's status, and executes the application.

According to another aspect of the present invention, there is provided a method of managing a telematics application based on a vehicle's status, comprising: (a) setting execution condition information including information related to a vehicle's status at which the application is activated; (b) detecting the vehicle's status; and (c) recognizing the application that is activated when in the detected vehicle's status, and executing the application.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a structure of an apparatus for managing a telematics application based on a vehicle's status according to an embodiment of the present invention;

FIG. 2 is a functional flowchart of an apparatus for managing a telematics application based on a vehicle's status according to an embodiment of the present invention;

FIG. 3 is a flowchart of a method of managing a telematics application based on a vehicle's status according to an embodiment of the present invention;

FIG. 4 is a flowchart of the process of installing the application of FIG. 3;

FIG. 5 illustrates an example of an application script used in the method illustrated in FIG. 4;

FIG. 6 is a flowchart of the process of activating the application illustrated in FIG. 3; and

FIG. 7 is a flowchart of the process (operation S320) of activating the application illustrated in FIG. 3 according to another embodiment of the present invention.

### DETAILED DESCRIPTION OF THE INVENTION

Now, exemplary embodiments of the present invention will be described in detail with reference to the accompanying drawings.

Examples of a vehicle's status include a driving status, an emergency status, a diagnosis status, and a normal status. If required, additional statuses may be added or deleted. The driving status is defined as a status in which a vehicle is operating. In this status, to ensure safety of the vehicle, execution of applications has to be restricted so that playing games or watching videos is not allowed while driving. Furthermore, an input/output mode of an available application has to be shifted into an audio based mode. When the emergency status is detected while driving due to an abnormal condition of the vehicle, unimportant applications need to be stopped so as to ensure the availability of all necessary resources, and thus an emergency situation has to be dealt with by activating applications for handling the emergency situation. When the vehicle or a terminal requires diagnosis, the vehicle goes into the diagnosis status. In this status, all applications requiring diagnosis are stopped, and the vehicle is remotely diagnosed, or the terminal is diagnosed. In addition, installed applications are diagnosed or upgraded. If the vehicle does not belong to any one of the above statuses, the vehicle is in the normal status, and all applications are allowed to be performed in this status.

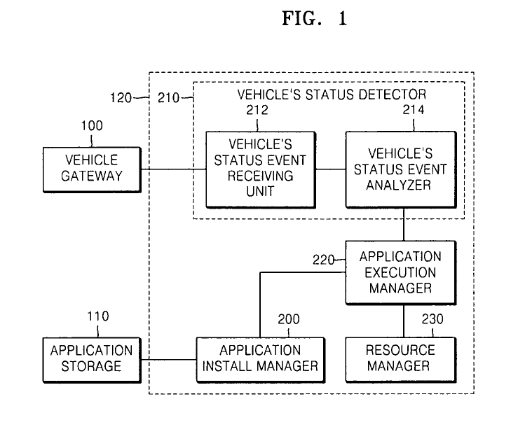

FIG. 1 is a block diagram of a structure of an apparatus for managing a telematics application based on a vehicle's status according to an embodiment of the present invention. In brief, FIG. 1 illustrates a vehicle gateway 100, an application storage unit 110, and an apparatus 120 for managing a telematics application based on a vehicle's status.

The vehicle gateway 100 collects information that is acquired through inter-vehicle communication such as a control area network (CAN) or a local interconnect network (LIN), and outputs an event signal used when a vehicle status is determined based on the collected information. A variety of sensors may be attached to the vehicle. All information related to the vehicle status is received via the vehicle gateway 100. Examples of event signals related to the vehicle's status include basic information on the vehicle (e.g., present speed, engine status, sheet position, airbag unfolding status, etc) and information on an internal vehicle sensor (e.g., a wiper sensor, a tire pressure sensor, etc).

The apparatus 120 for managing a telematics application based on a vehicle's status receives an event signal in association with a vehicle's status from the vehicle gateway 100, and detects a vehicle's present status. Thereafter, the apparatus 120 for managing a telematics application based on a vehicle's status executes or stops an application stored in the application storage unit 110, and, according to whether the application will be activated or not, ensures or removes a resource necessary to execute the application.

Specifically, the apparatus 120 for managing a telematics application based on a vehicle status includes an application install manager 200, a vehicle's status detector 210, an application execution manager 220, and a resource manager 230.

For each installed application, the application install manager 200 sets application execution condition information based on a vehicle's status. For example, whenever an application is installed, an execution condition may set whether the application is executed when in the emergency status, or in the driving status. In general, the application is stored in the application storage unit 110 after being installed via the application install manager 200. However, the present invention is not limited thereto, and the execution condition information may be modified after the application is installed.

The vehicle status detector 210 detects a vehicle's status by using the event signal received from the vehicle gateway 100, and outputs the detected vehicle's status. Specifically, the vehicle's status detector 210 may include a vehicle's status event receiving unit 212 and a vehicle status event analyzer 214.

The vehicle's status event receiving unit 212 receives the event signal from the vehicle gateway 100, converts the received event signal into a specific massage, and outputs the converted massage. That is, event signals in association with a variety of vehicle's statuses which are periodically received from the vehicle gateway 100 are converted into specific messages. The messages have a format that can be analyzed and displayed on a telematics terminal. For example, if a signal that indicates an airbag is unfolded is received, the signal may be converted into a message having a value of 0×1100. In addition, if a signal that indicates an engine is abnormal, the signal may be converted into a message having a value of 0×1001.

The vehicle status event analyzer 214 analyses a vehicle's status based on a message received from the vehicle's status event receiving unit 212, and outputs the vehicle's status information. That is, by analyzing the message, the vehicle's status event analyzer 214 classifies the vehicle's status into the driving status, the emergency status, the diagnosis status, the normal status, and the like. For example, if the airbag is unfolded, or an abnormality of the engine is detected, the vehicle goes into the emergency status. In addition, if a tire pressure is lower than a reference level, or an abnormality of a corresponding device is detected, the vehicle goes into the diagnosis status. The vehicle may go into the driving status by taking a vehicle's speed and an engine status into account.

According to the application execution condition information, the application execution manager 220 performs an activation function, for example, executes or stops the application, based on the detected vehicle status.

According to whether the application will be activated or not, the resource manager 230 ensures or removes a required resource. That is, the resource manager 230 ensures a resource required for executing an importance application when in an emergency situation. Furthermore, in order to ensure safe driving, the resource manager 230 ensures a resource required for audio announcement when in the driving status. In addition, the resource manager 230 manages a variety of devices connected to the telematics terminal. Specifically, the application execution manager 220 may, for example, determine whether the application will be activated or not, and then generate resource management control information to be provided to the resource manager 230. Thereafter, the resource manager 230 may control the resource based on the result thereof. However, the present invention is not limited thereto.

Furthermore, the apparatus 120 for managing the telematics application may be implemented by grading the vehicle's statuses such as the emergency status, the driving status, the diagnosis status, the normal status, and the like according to priority in terms of importance and emergence. For example, the emergency status, the driving status, the diagnosis status, and the normal status may be respectively graded 4, 3, 2, and 1.

For each installed application, the application install manager 200 determines a level of a vehicle's status at which the application is executed, as the execution condition information. For example, the execution condition information of the application for handling the emergency situation includes information that indicates level 4.

The application execution manager 220 compares a level of a vehicle's status included in execution condition information of the application with a level of the detected vehicle's status, and determines whether to activate the application or not. For example, if the detected vehicle's status is the driving status, an application corresponding to level 3 is executed, while execution of an application corresponding to the level 4 is not taken into account, and applications corresponding to levels 1 and 2 are stopped. When it is said that the execution of the application corresponding to the level 4 is not taken into account, it means that an application currently being executed is not stopped, or an application not being executed is not activated.

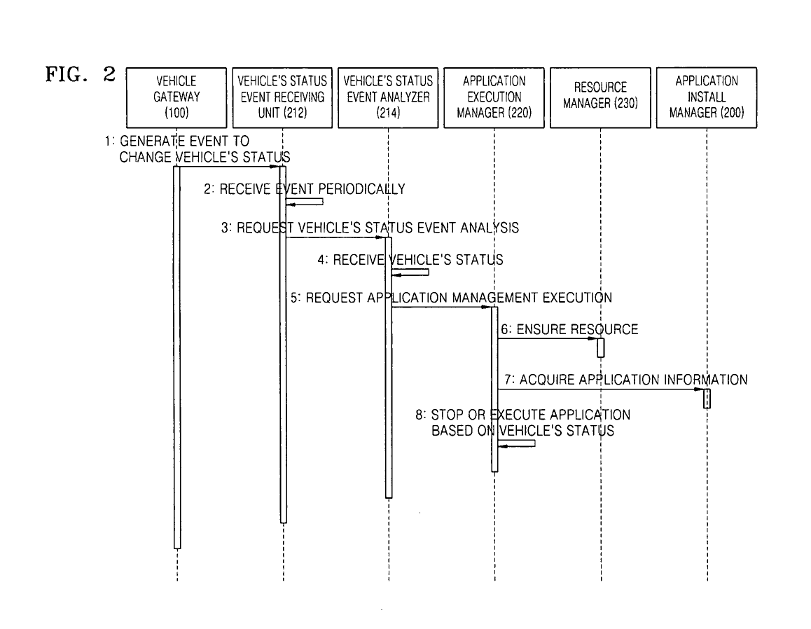

FIG. 2 is a functional flowchart of an apparatus for managing a telematics application based on a vehicle's status according to an embodiment of the present invention.

First, the vehicle's status event receiving unit 212 periodically receives an event signal generated in the vehicle from the vehicle gateway 100, and converts the event signal into a message. Thereafter, the vehicle's status event receiving unit 212 provides the message converted from the event signal to the vehicle's status event analyzer 214 while requesting a vehicle's status analysis.

The vehicle's status event analyzer 214 determines whether the message corresponds to the driving status, the emergency status, the diagnosis status, or the normal status.

Based on the determined vehicle's status, the application execution manager 220 acquires information that is input when an application is installed, that is, execution condition information, from the application install manager 200. Furthermore, the application execution manager 220 sends a command for ensuring or removing a resource based on the acquired information or the vehicle statue to the resource manager 230, thereby executing or stopping the application. The application execution manager 220 ensures or removes the resource according to the result thereof.

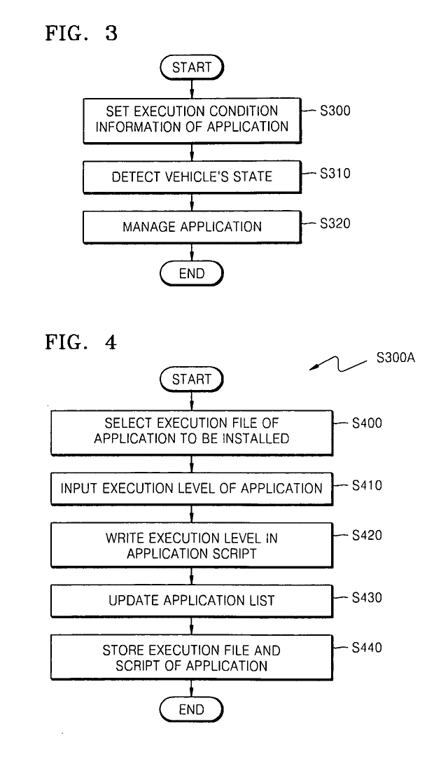

FIG. 3 is a flowchart of a method of managing a telematics application based on a vehicle's status according to an embodiment of the present invention.

First, applications required for the telematics terminal are installed by using the application install manager 200, and execution conditions are determined for each of the applications to be stored as execution condition information (operation S300). In the following descriptions, the number of applications to be installed is assumed to be N.

The vehicle's status detector 210 detects a vehicle's status by using an event signal received from the vehicle gateway 100 (operation S310). That is, when modification of the vehicle's status is detected, the vehicle's status is detected, and is stored as a current state (CS) of the vehicle. Specifically, operation S310 may be composed of a conversion process, in which the vehicle's status event receiving unit 212 converts the event signal into a specific massage, and a determination process, in which the vehicle's status analyzer 214 determines a vehicle's status based on the message. That is, the received massage is analyzed in order to be classified into the driving status, the emergency status, the diagnosis status, the normal status, and the like.

Based on the detected vehicle's status and the execution condition information received from the application install manager 200, the application execution manager 220 respectively determines whether the applications will be activated or not, and then executes or stops the applications accordingly (operation S320). Before the applications are executed or stopped, a process in which the resource manager 230 ensures or removes a resource, according to whether the resource is required for executing the resource, may be added.

FIG. 4 is a flowchart of the process of installing the application (operation S300) of FIG. 3.

First, a user selects an execution file of an application to be installed (operation S400). Next, the user inputs execution condition information of the application (operation S410).

After operation S410, the execution condition information is stored in an application script (operation S420), and then an application list is updated (operation S430). Finally, the execution file and the application script are stored (operation S440). In this case, the list and the script may be stored in the application storage unit 110 or the application install manager 200.

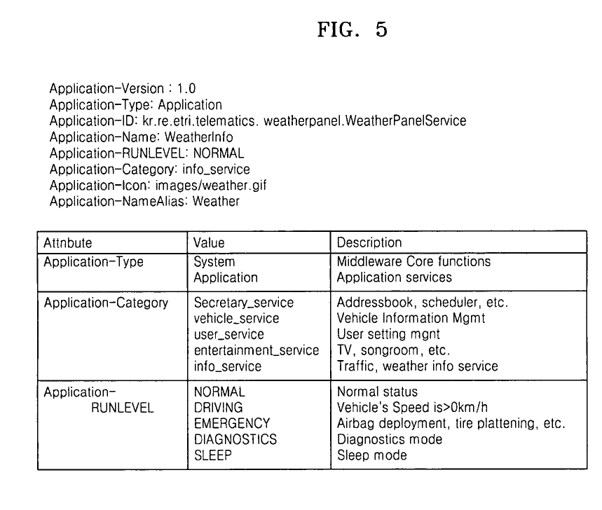

FIG. 5 illustrates an example of the application script used in the method of FIG. 4. An application version, type, ID, name, and the like are stored in the application script. In particular, a level (execution level) of a vehicle's status shows an emergency status. A starting point, an import package, execution condition information, and the like are stored in each application script, along with the application name. The level of the activated vehicle's status is defined as the emergency status, the diagnosis status, the driving status, or the normal status. As described above, the emergency, diagnosis, driving, and normal statuses may be respectively graded 4, 3, 2, and 1, according to priority.

An example of the application script used the method of FIG. 4 is shown in the upper side of FIG. 5. A table exemplifying an application-type, an application-category, and an application-run level included in the script is shown in the lower side of FIG. 5.

The script shown in FIG. 5 is used when an application is installed and when execution is managed according to a vehicle's status. A version, type, ID, name, and so on related to an application to be installed is written in this script, and in particular, an execution level of the vehicle's status to be activated is written as a normal status. That is, not only an application name but also a starting point, a package in use, execution condition information, and so on are stored in each application script. A level of the vehicle's status to be activated is defined as an emergency status, a diagnosis status, a driving status, or a normal status. As described above, different values may be assigned according to priority, for example, such that the emergency status is the level 4, the diagnosis status is the level 3, the driving status is the level 2, and the normal status is the level 1. In addition, according to another embodiment of the present invention, as shown in the table illustrated in the lower side of FIG. 5, the execution level of the vehicle's status further includes a sleeping mode. Meanwhile, applications are classified into an application to be excluded in an execution management and an application to be subjected to an execution management. Referring to the lower side of FIG. 5, the former application has a system as an application-type, whereas the latter application has an application as an application-type. That is, the former application performs a core function of the system, and the latter application is executed or stopped based on a vehicle's status and a specified execution level.

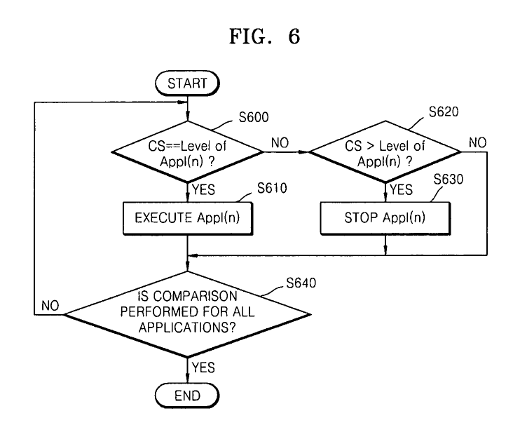

FIG. 6 is a flowchart of the process of activating the application (operation S320) of FIG. 3.

First, for each installed application, it is determined whether a level (level of appl(n)) of a vehicle's status included in execution condition information coincides with a level (CS) of a detected vehicle's status (operation S600). In this operation, the level of the vehicle's status may be determined such that the emergency status is 4, the diagnosis status is 3, the driving status is 2, and the normal status is 1, where the greater the number, the higher the priority. In addition, n denotes an application index, and has a value ranging from 1 to n. That is, appl(n) means an nth application.

In operation S600, if the level of the vehicle's status included in the execution condition information coincides with the level of the detected vehicle's status, a corresponding application is executed (operation S610). Otherwise, it is determined whether the level of the detected vehicle's status is greater than the level of the vehicle's status included in the execution condition information (operation S620).

In operation S620, if the level of the vehicle's status included in the execution condition information is determined to be greater than the level of the determined vehicle's status, the application is stopped (operation S630). Otherwise, operation 640 is performed.

Next, it is determined whether the above comparison is performed for all applications (operation S640). In operation S640, if there are remaining applications required to be compared, operation S600 is performed. Otherwise, an application execution management operation is completed.

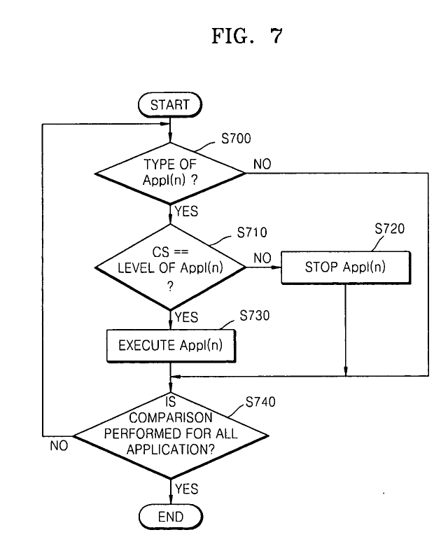

FIG. 7 is a flowchart of the process (operation S320) of activating the application illustrated in FIG. 3 according to another embodiment of the present invention.

In operation S700, it is checked for each installed application whether a value of application-type included in execution condition information coincides with application. In this operation, n denotes an application index in the range of 1 to N. That is, appl(n) means an nth application. If the value of application-type is application, operation S710 is performed, and otherwise, operation S740 is performed. This is because an application having a system as the value of application-type performs a core function of the system, and thus the above application is excluded in an execution management.

The level of appl(n) included in the execution condition information of the above application is compared whether to coincide with a current state (CS) of a detected level of appl(n) (operation S710). In the case of coincidence, the application is executed (operation S730), and otherwise, the application is stopped (operation S720). As described above, for example, the level of appl(n) may be defined such that the emergency status is 4, the diagnosis status is 3, the driving status is 2, and the normal status is 1. Further, the level of appl(n) included in the execution condition information may have a plurality of levels. For example, in the case of a navigation application, since it can be executed in the normal status and the driving status, the level of appl(n) included in the execution condition information of the navigation application can be both 2 and 1. In this case, if any one of the plurality of levels of appl(n) included in the execution condition information coincides with the detected level of appl(n) (operation S710), then operation 730 is performed.

Next, it is determined whether the above operation is performed for all applications (operation S740). In operation S740, if there are remaining applications required to be compared, operation S700 is performed. Otherwise, an application execution management operation is completed.

Now, an example of an application execution management task will be described in detail. When the vehicle starts to move, the vehicle's status changes to the driving status. Thus, only an application having execution condition information including the level of the vehicle's status of ‘driving status’ is executed when the vehicle's status coincides with the driving status, and the rest of applications are stopped. Thereafter, if an airbag is unfolded during driving, or if the vehicle has a flat tire, the vehicle's status changes from the driving status to the emergency status. In this case, an application for handling the emergency status is executed, and the rest of applications are stopped.

Meanwhile, in the case of a general entertainment application, in order to avoid interruption during driving, the execution condition information of the application includes a level of the vehicle's status, that is, ‘normal status’, and the execution of the application is stopped when the current state of the vehicle coincides with the driving status.

Accordingly, an application execution for a telematics terminal is controlled based on a present status of a vehicle, so as to ensure safe driving. Furthermore, when in an emergency situation, a resource can be rapidly ensured, and applications for handling the emergency situation are executed, thereby effectively overcoming the emergency situation.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for managing a telematics application based on a vehicle's status, comprising:
an application install manager which sets execution condition information including information related to a vehicle's status at which the application is activated;
a vehicle's status detector which detects the vehicle status; and
an application execution manager which recognizes the application that is activated when in the detected vehicle's status, and executes the application.

2. The apparatus of claim 1, wherein the vehicle's status includes at least one of a driving status in which the vehicle is operating, an emergency status in which the vehicle is abnormal while driving, and a diagnosis status in which the vehicle requires diagnosis.

3. The apparatus of claim 1, wherein:
the application install manager sets a level of a vehicle's status at which the application is executed as the execution condition information by using the vehicle's statuses graded according to priority, and
the application execution manager compares a level of a vehicle's status included in the execution condition information with a level of the detected vehicle's statue, and determines whether the application is to be activated or not.

4. The apparatus of claim 1, wherein the vehicle's status detector comprises:
a vehicle's status event receiving unit which receives an event signal related to the vehicle's status from a vehicle gateway, and converts the event signal into a specific massage; and
a vehicle's status event analyzer which determines the vehicle status based on the message.

5. The apparatus of claim 1, wherein the application execution manager recognizes a resource required for the application to be activated, and further includes a resource manager which ensures the recognized resource.

6. A method of managing a telematics application based on a vehicle's status, comprising:
(a) setting execution condition information including information related to a vehicle's status at which the application is activated;
(b) detecting the vehicle's status; and
(c) recognizing the application that is activated when in the detected vehicle's status, and executing the application.

7. The method for claim 6, wherein the vehicle's status includes at least one of a driving status in which the vehicle is operating, an emergency status in which the vehicle is abnormal while driving, and a diagnosis status in which the vehicle requires diagnosis.

8. The method for claim 6, wherein:
in (a), a level of a vehicle's status at which the application is executed as the execution condition information is set by using the vehicle statuses graded according to priority, and
in (c), a level of a vehicle's status included in the execution condition information is compared with a level of the detected vehicle's status, and determines whether the application will be activated or not.

9. The method of claim 6, wherein, in (a), execution condition information of the application is set whenever the application is installed.

10. The method for claim 6, wherein (b) comprises:
(b1) receiving an event signal related to a vehicle's status from a vehicle gateway, and converting the event signal into a specific massage; and
(b2) detecting the vehicle's status based on the message.

11. The method for claim 8, wherein (c) comprises:
(c1) comparing a level of a vehicle's status included in the execution condition information with a level of the detected vehicle's status;
(c2) executing the application if the level of the vehicle's status included in the execution condition information coincides with the level of the detected vehicle's status in (c1); and
(c3) stopping the application if the level of the vehicle's status included in the execution condition information is less than the level of the detected vehicle's status in (c1).

12. The method of claim 6, further comprising
(d) managing a resource by ensuring or removing the resource according to whether the application is activated.

13. A computer-readable medium having embodied thereon a computer program for executing the method of claim 6.
